(19) United States
(12) Patent Application Publication
(10) Pub. No.: US 2005/0221256 A1
(43) Pub. Date: Oct. 6, 2005

(54) Root canal instrument

(76) Inventor: Pekka Kangasniemi, Turku (FI)

Correspondence Address: STEINBERG & RASKIN, P.C., 1140 AVENUE OF THE AMERICAS, 15th FLOOR, NEW YORK, NY, 10036-5803, US

(21) Appl. No.: 10/517,033

(22) PCT Filed: Jul. 2, 2003
(86) PCT No.: PCT/FI03/00537

§ 371 Date: Apr. 29, 2005

(30) Foreign Application Priority Data
Jul. 2, 2002 (FI) 20021306

(51) Int. Cl. A61C 5/02

(52) U.S. Cl. 433/102

(57) ABSTRACT

A root canal instrument comprising a gripping end which is substantially cylindrical handgrip part, and a metallic needle part for working the tooth. An upper end of the needle-like actual working part is inserted into the gripping end either through part of the length or the entire length of the gripping end. The outer surface of the gripping end is substantially continuous, the coefficient of friction of the material used in the outer surface of the gripping end is higher than the coefficient of friction of the material typically used in gripping ends of root canal instruments made of metal, polyphenylene sulfide or a similar material. The hardness of at least the material used in the outer surface of the gripping end as well as the thickness of the material layer are so chosen that the shape of the gripping end is recoverably deformable between the fingers of the person performing the root treatment.

The invention relates to a root canal instrument as presented in the preamble of claim 1.

The invention is applicable for use in root treatment of teeth to perform the preparation of root canals, i.e. the mechanical cleaning and shaping of the root canal using a manually operated instrument. In the preparation, the root canal of a tooth is opened from inside, cleaned and possibly enlarged to allow medical treatment and final filling of the root canal. Manual root canal instruments include e.g. reamers provided with various thin and flexible metal needles and root files having a gripping end that allows as good a finger grip as possible. In addition to a good finger grip, the gripping end must have a good resistance to the effects of both root canal treatment and cleaning and disinfecting e.g. using an autoclave, where the gripping end is exposed to high temperatures.

Prior-art root canal instruments in general use are provided with a gripping end made of either a metal material suited for the purpose or a hard plastic mixture that withstands autoclave or equivalent sterilizing treatment and other maintenance treatments. A plastic mixture applicable for this purpose, which has been used in dental care in recent yeas, is polyphenylene sulfide. Although this plastic mixture has the advantage of a good resistance to chemicals and heat, it also has its drawbacks, such as hardness and surface slipperiness. A typical gripping end of a manual root canal instrument has a diameter of only e.g. about 2-4 mm and a length of about 5-20 mm. The root canal instrument is handled in patient's mouth via its gripping end in very cramped conditions by rotating it back and forth between the thumb and the forefinger, or another finger, through an angle of about 90° at the most and by performing a filing and grinding movement in the lengthwise direction of the root canal. The flush water and saliva often add to the slipperiness of the already in itself slippery surface of the gripping end, so that the person performing the treatment has to press the gripping end even more tightly to have a grip that gives as firm a hold and good working feel as possible.

Because of the difficulties in handling and controlling the instrument, its working tip may damage the root canal, in the worst case even pierce a hole in the root canal. Moreover, sensitivity and precision are impaired due to harder pressing and use of greater force, which may result in the needle of the instrument snapping inside the tooth being treated. All reparatory operations are generally difficult, time-consuming and expensive, and e.g. in the case of a snapped needle may even lead to the loss of the tooth, in case one does not manage to remove the snapped needle from the tooth. A further problem is that, as a result of hard and prolonged pressing required, the person's fingers and hands often suffer strain lesions and occupational diseases. In addition, when used continuously, the hard gripping end may cause calluses to the fingertips, which are a health handicap and a hindrance to accurate working. Moreover, there is the risk that the slippery instrument may slip from the grip of the fingers and fall into the patient's mouth, or with still worse luck get into the patients throat and further into the gullet and the digestive tract. In this case, the instrument can only be extracted by surgery.

To correct the above-mentioned drawbacks, gripping end allowing a better finger grip have been developed. One prior-art solution is described in U.S. Pat. No. 4,859,183, in which, to provide a better finger grip, a cylindrical gripping end has a cross-sectional form such that it has two opposite flat sides parallel to each other and a curved portion between the aforesaid flat sides. In addition, the gripping end is provided with transverse grooves spaced evenly in the axial direction. In the patent, it is stated in a general way that the gripping end may be made of metal, plastic, silicone or any other suitable material, but the patent makes no specific reference to the hardness of the gripping end, nor to the friction of the material of the gripping surface. Clearly, thus, no attention has been paid here to the choice of material with respect to working ergonomics, but only materials already in use or possibly suited for use for this purpose are listed in general. The repetitive stress problems caused by long-term pressing are still present in this invention when such metal or plastic materials that are currently in use are used. Point-form stress at the points of pressure is even higher than in the case of a gripping end without grooves. The vertical comers between the flat and the round sides also increase the point-form stress. In addition, the numerous grooves and the sharp inner comers between them are apt to gather bacteria and impurities, which may be difficult to remove in connection with the maintenance process.

Another prior-art root canal instrument is represented by a solution disclosed in U.S. Pat. No. 5,516,287. In this solution, the handling properties and control of the instrument have been improved by adding rings around the cylindrical surface of a cylindrical gripping part at axial distances from each other, said rings being made of silicone rubber to provide better stickiness. The rings improve adhesive ability somewhat due to greater friction, but only in the area of just the ring itself. However, the overall improvement in stickiness is questionable, because fingers of the person performing the treatment do not necessarily meet the entire gripping surface but only the rings, which means that the available friction surface remains smaller than normally. In addition, the body part of the gripping end is still of hard material, and therefore prolonged pressing causes problems as described above in the fingers and hands of the person performing the treatment. Neither are the thin silicone rings elastic enough in order to sufficiently reduce the pressure on the fingers. A further drawback are the seam areas between the silicone rings and the body part made of a another material, which may be damaged and open e.g. so that bacteria and impurities can get into a seam which has been slightly burst open. Such seams may be difficult to sterilize in a completely reliable manner. A further drawback is a difficult and expensive manufacturing process.

Anti-slip elastic coatings made of elastomers, such as polyurethanes and other thermoplastic elastomers, have been used in many tools. However, the hand-grips used to hold tools are typically different from those required in the case of root canal instruments, which are handled using only the fingertips, and therefore the solutions used in tools are not directly and self-evidently applicable for use in root canal instruments.

The object of the present invention is to reduce the aforesaid drawbacks and to achieve an ergonomic root canal instrument that is applicable for use in root treatment of teeth and has good handling properties and can be manufactured relatively economically.

Regarding good handling properties of the gripping end, of essential importance are the properties of its material together with the form of the surface of the gripping end. According to the invention, the sufficiently elastic and frictional material allows the root canal instrument to be held by a light grip without its gripping end having to be provided with any protrusions or similar forms to prevent slipping of the grip, the working accuracy being thus improved and the risk of work-based strain injuries considerably reduced. The material of the gripping end according to the invention has been so chosen that it will enable as good gripping of the instrument as possible. An essential feature of such a material is that its coefficient of friction is higher than that of the gripping ends of root canal instruments in general use. A considerable additional advantage of one of the materials according to the invention, i.e. silicone, in respect of dental care practices is that, in addition to being elastic and frictional, it is also well able to withstand disinfecting and sterilizing processes.

Trying to accurately define the coefficient of friction of elastomers in the environment of application of the invention would be quite vague, because the counter-pair substances could then be, inter alia, dry or wet skin, the wetting agent being e.g. saliva, and correspondingly e.g. a latex material as used in dentists' gloves. On the other hand, such handling properties the invention deals with may also be influenced e.g. by the thickness of the surface material layer. Therefore, what is relevant according to the invention is to use a material that provides a good working grip as a combination of material elasticity and friction, with a substantially continuous surface form of the gripping end of the instrument. The root canal instrument according to the invention is characterized by what is presented in the characterizing part of claim 1. Other preferred embodiments of the invention are characterized by what is presented in the other claims.

The solution according to the invention has the advantage of making it possible to achieve a reliable root canal instrument with good handling properties and controllability, the use of which does not cause excessive strain of the fingers or hands thanks to the soft elasticity and deformability of the gripping end and the even surface pressure applied to the fingers, which is made possible by the form of the surface of the gripping end. In addition, due to the good stickiness, the instrument can be held firmly between fingers, and the risk of it slipping off is not as high as when prior-art root canal instruments are used.

In the following, the invention will be described in detail by the aid of an exemplary embodiment with reference to the attached drawings, wherein

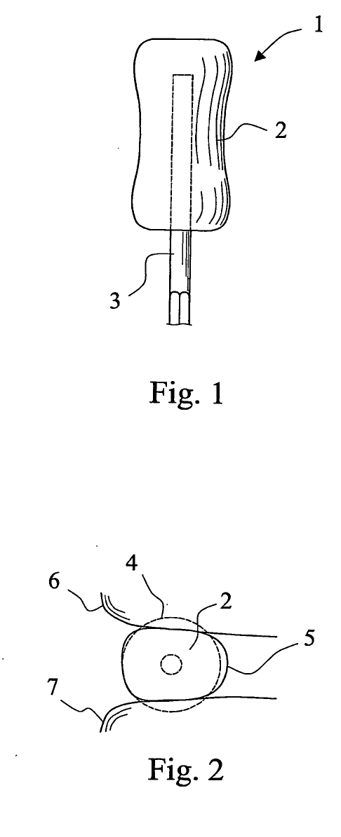

FIG. 1 presents a side view of a gripping end of a root canal instrument according to an embodiment of the invention,

FIG. 2 presents a gripping end of the root canal instrument illustrated in FIG. 1 as seen from one end,

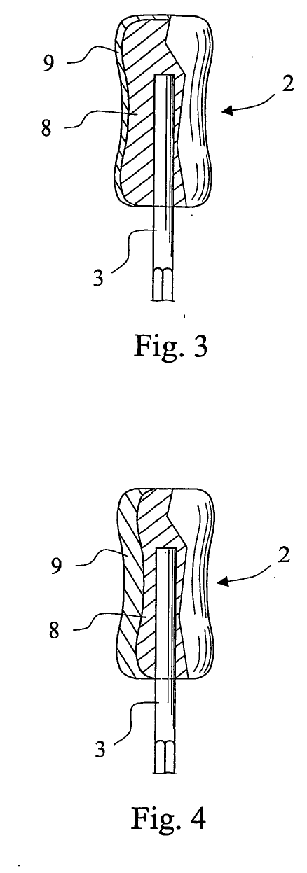

FIG. 3 presents a partially sectioned side view of a gripping end of a root canal instrument according to a second embodiment of the invention, and

FIG. 4 presents a partially sectioned side view of a gripping part of a root canal instrument according to a third embodiment of the invention.

In its simplest form, the root canal instrument 1 presented in FIG. 1 consists of two main parts: a substantially cylindrical handgrip part, which in this context is referred to as a gripping end 2, and a needle-like actual working part 3 made of metal, the upper end of which is inserted into the gripping end either through part of the length of the gripping end or through its entire length. The substantially cylindrical outer surface of the gripping end 2 is designated here as the handgrip surface. The working part 3 may be designed to perform a back-and-forth longitudinal or rotatory movement relative to the root canal, or combinations of such movements. The working part is generally shaped in a manner specific to each type of working movement mentioned above. During the pretreatment, i.e. preparation of a tooth requiring root treatment, generally many needles of different thicknesses are used in succession starting with the thinnest one, which opens the root canal, and then gradually applying thicker needles. The task may take a long time and is therefore very stressful to the fingers and hands of the person performing the preparation.

It is very important that the gripping end 2 has good handling properties. The handling properties and therefore the controllability and successful execution of the entire preparation operation depend on things like size, shape, hardness and surface slipperiness of the gripping end 2. The gripping end 2 according to the invention is substantially of normal size as compared with other gripping ends in general use. The shape of the gripping end in itself is not essential to the invention, as long as its surface is substantially continuous. However, a typical shape is one resembling an elongated cylinder in which the cylinder diameter diminishes smoothly from each end of the gripping end 2 axially towards the middle part of the gripping end.

The material of the gripping end according to the invention has been so chosen that the handgrip surface of the gripping end will provide as good a grip for the fingers of the person performing root treatment as possible. The material is therefore chosen expressly such that its coefficient of friction is higher, preferably substantially higher than the coefficient of friction of the material of the gripping ends of root canal instruments in general use.

In literature, friction coefficients are often given as coefficients of kinetic friction e.g. against a steel surface. Typically, such a friction coefficient for steel may be 0.4 for dry steel and 0.05 for lubricated steel. Correspondingly, for the friction coefficient of polyphenylene sulfide (PPS) against steel, literature presents values between 0.2 . . . 0.4, of which 0.4 corresponds to a value for “pure” PPS without any additives reducing the friction coefficient. The corresponding friction coefficient of polytetrafluoroethylene, i.e. e.g. Teflon, which can withstand autoclave sterilization, is about 0.05.

The coefficient of kinetic friction for the above-mentioned materials against steel thus varies in the range of 0.05 . . . 0.4. Correspondingly, the coefficient of kinetic friction of the material of the gripping end according to the invention against steel is higher than the aforesaid maximum value 0.4, preferably substantially higher than this, such as e.g. in the range of about 0.5 . . . 0.8, most suitably about 0.7 . . . 0.8—in other words, substantially higher than the friction coefficient of prior-art gripping ends made of metal, polyphenylene sulfide or corresponding materials.

As the gripping end allows a sufficient frictional force, according to the invention, the handgrip surface of the gripping end can be made substantially continuous and smooth so that the gripping end has no such comers which would be difficult to clean and that pressing it will not produce any point-like or local pressure loads on the fingers.

Besides the higher frictional force, the material hardness of the gripping end 2 has been so chosen that, when the gripping end 2 is pressed by fingers 6, 7, it will elastically and appropriately deform between the fingers. Thus, the preferably round basic cross-sectional form of the gripping end can be recoverably deformed between the fingers of the person performing root treatment. This property is demonstrated in an exaggerated way in FIG. 2. Here, the normal round free form, i.e. the basic form of the cross-section of the gripping end 2 is indicated by reference number 4, and the form temporarily modified between the fingers 6, 7 is indicated by reference number 5. The material for the gripping end 2 has to be selected considering that the material may not be too soft, because that would impair the controllability of preparation. On the other hand, too hard a material will not have a sufficient elasticity, causing stress lesions as mentioned above. The gripping end 2 according to the invention for a root canal instrument, or at least its surface layer is made of substantially homogeneous material such that the gripping end 2 has a material hardness substantially in the range of 10 . . . 95 Shore A, suitably in the range of 30 . . . 95, preferably in the range of 50 . . . 85 and most suitably about 60 . . . 70 Shore A. Such a gripping end 2 gives a good working feel and causes as little stress to the fingers and hands of the person performing preparation as possible. As stated above, the material of the gripping end 2 according to the invention is substantially softer than the material of a metallic gripping end or a gripping end made of polyphenylene sulfide or a similar material generally used. A material alternative according to the invention is an elastomer of a suitable hardness, such as silicone rubber, which can well withstand disinfecting chemicals and the conditions of autoclave or equivalent sterilizing treatment.

FIGS. 3 and 4 present two different further embodiments of the invention. In the solution illustrated in FIG. 3, the gripping end 2 consists of at least two different materials, so that the inner core material 8 may be a suitable metal, metal mixture, plastic or elastomer harder than the surface layer 9, and the outer surface layer 9 consists of a softer elastomer as mentioned above, e.g. silicone rubber, which gives the gripping end 2 elasticity and ensures a good frictional hold. The thin surface layer 9 covers substantially evenly at least the entire cylindrical surface of the gripping end, i.e. the handgrip surface. In the embodiment according to FIG. 3, the surface layer 9 also covers the outer end surface of the gripping end 2. If the aforesaid surface layer 9 is substantially thin, then its hardness is preferably somewhat lower, most suitably by about 5 . . . 10 units Shore A lower than the above-described values than in the case where the entire gripping end 2 has been made of a homogeneous material having the properties according to the invention.

FIG. 4 presents a solution where the surface layer 9 is an elastomer layer thicker than in the solution presented in FIG. 3. In other respects, the surface layer 9 and the core material 8 may be of the same material as in the gripping end according to FIG. 3. In this solution, however, the surface layer 9 does not cover the outer end surface of the gripping end 2 but only the handgrip surface as defined above. The solution illustrated in FIG. 4 is an intermediate form between the embodiments presented in FIG. 1 and FIG. 3. In this case the surface layer 9 provides a good frictional hold and, due to its softness and greater thickness, it may additionally be deformed under the pressure of the fingers of the person performing the treatment, and thus be temporarily deformed, more than in the solution according to FIG. 3.

A feature common to all the above-described embodiments is the continuous, substantially smooth surface of the handgrip surface of the gripping end 2, which provides a good frictional hold and which is made of a material substantially softer than metal or plastic generally used for this purpose, such as polyphenylene sulfide (PPS). In addition, the hardness of at least the material used in the outer surface of the gripping end 2 as well as the thickness of the material layer are so chosen that the gripping end 2 is recoverably deformable between the fingers.

It is obvious to a person skilled in the art that the invention is not limited to the examples described above, but that i may be varied within the scope of the claims presented below. Thus, for example, the shape and material of the gripping end 2 may differ from those described above. Similarly, the form and thickness of the core material 8 and surface layer 9 of the gripping end 2 as well as the ratio between their thicknesses may differ from those described above. In addition, the diameter of the gripping end may be somewhat larger than normally in order to achieve better handling properties.

1. Root canal instrument (1), which includes a metallic needle part (3) for working the tooth and a gripping end (2) attached to the upper end of the needle part to serve as a handle, wherein the outer surface of the gripping end (2) is substantially continuous, that the coefficient of friction of at least the material used in the outer surface of the gripping end is higher than the coefficient of friction of the material typically used in gripping ends of root canal instruments made of metal, polyphenylene sulfide or a similar material, and that the hardness of at least the material used in the outer surface of the gripping end as well as the thickness of this material layer are so chosen that the shape of the gripping end (2) is recoverably deformable between fingers.

2. Root canal instrument according to claim 1, wherein the coefficient of friction of the material of the outer surface of the gripping end (2) is higher, preferably substantially higher than 0.4, determined as a coefficient of kinetic friction and with steel as a material pair.

3. Root canal instrument according to claim 2, wherein the aforesaid coefficient of friction of the material of the outer surface of the gripping end (2) is within the range of about 0.5 . . . 0.8, preferably 0.7 . . . 0.8.

4. Root canal instrument according to claim 1, wherein the gripping end (2) is made of a substantially homogeneous material.

5. Root canal instrument according to claim 1, wherein the gripping end (2), or at least its surface layer, is made of an elastomer having a hardness substantially in the range of 10 . . . 95 Shore A, preferably in the range of 30 . . . 95, suitably in the range of 50 . . . 85 and most suitably about 60 . . . 70 Shore A.

6. Root canal instrument according to claim 1, wherein the gripping end (2) has a surface layer (9), under which there is at least one layer of some other material.

7. Root canal instrument according to claim 6, wherein the said surface layer (9) is substantially thin, in which case it has a somewhat lower hardness, preferably about 5 . . . 10 units Shore A lower than the hardness of the said gripping end (2) made of a homogeneous material.
